(19) United States
(12) Patent Application Publication
(10) Pub. No.: US 2006/0050867 A1
(43) Pub. Date: Mar. 9, 2006

(54) Electronic apparatus and its openning closing mechanism

(76) Inventor: Masanobu Kawamoto, Kanagawa (JP)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/529,471

(22) PCT Filed: Jul. 1, 2003
(86) PCT No.: PCT/JP03/08346

§ 371 Date: Mar. 28, 2005

(30) Foreign Application Priority Data
Sep. 26, 2002 (JP) 2002-281582

(51) Int. Cl. H04M 1/00; H04M 9/00

(52) U.S. Cl. 379/433.13

(57) ABSTRACT

A cellular phone includes a monitor portion 20 that is swingably mounted to a body. During a state from a point that the monitor portion 20 is fully closed to a point that the monitor portion 20 is opened through 45°, a shaft portion 106 of a damper member 110 prevents a shaft portion 112 from being interlocked therewith, and thus no damping force is exerted with respect to swinging of the monitor portion 20 during the above state. Thus, the monitor portion 20 can be opened speedily. When the monitor portion is opened through an angle in excess of 45°, the shaft portion 106 permits the shaft portion 112 of the damper member 110 to be interlocked therewith, and a damping force by the damper member 110 works on the shaft portion 112. Thus, the monitor portion 20 is opened slowly.

### TECHNICAL FIELD

The present invention relates to a folding electronic device provided with a lid part that is arranged swingably with respect to a body part, and an opening/closing mechanism thereof.

### BACKGROUND ART

In recent years, as a result of increasing demands for user-friendliness of a hinge unit through which a transmitter portion of a cellular phone is mounted to a receiver portion thereof in a manner that it can be freely opened and closed, needs have arisen for a hinge unit which is arranged to permit a receiver portion to be opened in one touch operation with a single hand simply by depressing a button.

For example, in JP-A No. 10-51526 (pages 5-6, FIG. 2), as shown in FIGS. 16 and 17, a hinge unit 200 comprises a substantially cylindrical casing 202 in which are incorporated a first torsion coil spring 204, a fixation shaft 206, and a cap 208 on an X1 end side, and a first rotary shaft 210, a second torsion coil spring 212, a second rotary shaft 214, and a cap 216 on an X2 end side.

The second rotary shaft 214 is secured to a receiver portion (not shown). By swinging the receiver portion in a direction that it is closed, the second rotary shaft 214 is rotated so that an end portion 214A of the second rotary shaft 214 is pressed against a stopper (not shown) provided in the first rotary shaft 210, and the receiver portion is locked at a closed position by lock means while the first torsion coil spring 204 is being torsioned via the first rotary shaft 210.

That is, by swinging the receiver portion in a direction that it is closed, a resilient force is accumulated in the first torsion coil spring 204. Thus, by releasing the lock state at the closed position of the receiver portion, the receiver portion is opened due to a restoration force of the first torsion coil spring 204.

Meanwhile, on the outer peripheries of the fixation shaft 206 and second rotary shaft 214 are fitted O rings 218 and 220, respectively. A damper portion 222 is comprised of silicone oil 226 filled in a space 224 defined by the O rings 218 and 220, a pair of vane portions 210A and 210B extending in a fan-like form from the axis center of the fore end portion of the first rotary shaft 210 and adapted for stirring the silicone oil 226, and a flat surface portion 210C formed in the outer circumference of the first rotary shaft.

When the receiver portion is released from the closed state, the first torsion coil spring 204 changes from a state in which the respective turns thereof are in tight contact with each other to a state in which gaps occur between the respective turns thereof. At this point, the respective turns move in the space 224 and thus are subjected to a viscous resistance of the silicone oil 226 in the space 224 so that a damper effect is obtained.

Further, in JP-A No. 2001-165144 (pages 3-5, FIG. 5), although not shown in the drawings, a damper module is incorporated in a hinge connecting a transmitter portion and a receiver portion. The damper module is comprised of an oil damper unit and a one-way clutch unit which are provided in an interconnected state.

The oil damper unit is secured to the receiver portion, and the one-way clutch unit is fixed to the transmitter portion. It is arranged such that when the receiver portion is swung in an opening direction, a damper effect is obtained with the aid of the one-way clutch unit, while when the receiver portion is swung in a folding direction, no damper effect works.

With the above-described arrangement, when the receiver portion is opened, a damper effect is obtained so that the receiver portion is opened slowly. However, in the patent documents 1 and 2, there is a likelihood that the damper function will turn out to be insufficient with respect to the rotating speed of the receiver portion at the end of the opening operation since the braking force due to the damper function remains unchanged despite the fact that the rotating speed of the receiver portion increases from the start to the end of the opening operation.

Further, in JP-A No. 10-51526, the first torsion coil spring 204 of the opening/closing mechanism is equipped with a biasing function for biasing the receiver portion in the opening direction and a damper function for damping the opening of the receiver portion. Further, in the opening/closing mechanism of JP-A No. 2001-16514, an oil damper unit having a damper function and a one-way clutch unit having a biasing function are provided which are interconnected to each other. Therefore, the opening/closing mechanisms disclosed in the above-mentioned documents have only a limited freedom of design in that they are incapable of separating the biasing mechanism and the damper mechanism from each other.

### DISCLOSURE OF THE INVENTION

In view of the above facts, the present invention has for an object to achieve a folding electronic device that is capable of ensuring speedy-opening of the lid while producing a sufficient damping force even at the end of the lid opening operation and providing an increased freedom of design, and an opening/closing mechanism for such a folding electronic device.

A first aspect of the present invention is an electronic device having a body and a lid comprising: a spindle portion including a mechanism for supporting and permitting the lid to be swung in a direction that the lid is opened from a closed position where the lid is closed by folding with respect to the body; a biasing mechanism provided on the spindle portion for biasing said lid in the direction that the lid is opened, thereby enabling the lid to perform an opening operation; and a damper mechanism for damping the opening operation of the lid, the damper mechanism being arranged to perform no damping operation during a state in which the lid, when opened, is in a range from a fully closed position to an angle less than or equal to a predetermined angle, and to operate damping of the opening operation of said lid during a state in which said lid is opened through an angle in excess of the predetermined angle.

In one embodiment, the above aspect may include, in the spindle portion, a lock mechanism for holding the lid at the closed position when the lid is located at the closed position, and a release mechanism for releasing the holding of the lid by the lock mechanism. The lock mechanism holds the lid at the closed position in a state in which a biasing force by the biasing mechanism is permitted to be accumulated. The spindle portion includes a cam structure; the release mechanism includes a portion that is moved in response to a releasing manipulation, the release mechanism being connected to the cam structure via that portion; and the lid starts to be moved in an opening direction in response to the releasing manipulation.

The electronic device may include at least one additional spindle portion, whereby each of the biasing mechanism and the damper mechanism may be provided on a different one of the spindle portions.

The above-described damper mechanism may include an engaging mechanism; and the engaging mechanism include a shaft that releases interlocking with said lid during a state in which the lid, when opened, is in a range from a fully closed position to an angle less than or equal to a predetermined angle and interlocks with said lid during a state in which the lid is opened through an angle in excess of the predetermined angle. The damper mechanism includes a cylindrical container filled with a viscous medium; and said shaft has a blade body in the viscous medium and is rotatably supported.

A second aspect of the present invention is an opening/closing mechanism for an electronic device including a body and a lid, comprising: a spindle mechanism for supporting and permitting said lid to be swung in a direction that the lid is opened from a closed position that the lid is closed by folding with respect to the body; a biasing mechanism for biasing the lid in the direction that the lid is opened, thereby enabling the lid to perform an opening operation; and a damper mechanism for damping the opening operation of the lid, the damper mechanism being arranged to perform no damping operation during a state in which the lid, when opened, is in a range from a fully closed position to an angle less than or equal to a predetermined angle and to operate damping of the opening operation of the lid during a state in which the lid is opened through an angle in excess of the predetermined angle.

In one embodiment, the above second aspect may include a lock mechanism for holding the lid at the closed position when the lid is located at the closed position; and a release mechanism for releasing the holding operation by the lock mechanism, wherein the lock mechanism may be structured to hold the lid at the closed position in a state in which a biasing force by the biasing mechanism is caused to be accumulated.

The release mechanism includes a portion that is moved in response to a releasing manipulation when the releasing manipulation is performed, and said portion is connected to the lock mechanism to release the holding operation. The opening/closing mechanism further comprises a cam structure, said portion of the release mechanism being connected to the cam structure to permit the lid to start moving in an opening direction.

The biasing mechanism comprises an elastic member, and the lid is biased due to a restoration force of the elastic member. The elastic member comprises a coil spring.

The biasing mechanism and the damper mechanism are disposed to be combined with different portions of the spindle mechanism respectively. Alternatively, at least one additional spindle mechanism is provided, and each of the biasing mechanism and the damper mechanism is combined with a different one of the spindle mechanisms.

The damper mechanism includes an engaging mechanism; and the engaging mechanism includes a shaft that releases interlocking with the lid during a state in which the lid, when opened, is in a range from a fully closed position to an angle less than or equal to a predetermined angle, and interlocks with the lid during a state in which the lid is opened through an angle in excess of the predetermined angle.

The damper mechanism has a structure that produces a damping force by using the viscosity of a viscous medium. The damper mechanism includes a substantially cylindrical container filled with a viscous medium; and said shaft has a blade body in the viscous medium and is rotatably supported.

The predetermined angle is less than or equal to 90°.

The above-described electronic device is a cellular phone device having a receiver portion provided in said lid.

A third aspect of the present invention is a folding type electronic device wherein there is provided: a lid that is swingable with respect to a body, the electronic device comprising: a shaft portion about which the lid is swung; biasing means provided in said shaft portion for biasing said lid in an opening direction, thereby causing the lid to be opened, lock means for maintaining a closed position of the lid in a state in which an elastic force of said biasing means is accumulated; and damper means provided in said shaft portion, the damper means being arranged, after the lock means is released, to perform free running and release damping of a biasing force of the biasing means when the lid is positioned within a predetermined opening angle range, the damper means being also arranged to perform damping of a biasing force of the biasing means when the lid is positioned outside the predetermined opening angle range.

In the above third aspect, the biasing means for causing the lid to be opened is provided in the shaft portion (spindle portion) serving as a rotation axis about which the lid is swung, and a closed state of the lid is maintained by the lock means in a state in which an elastic force of the biasing means is accumulated. After the lock means is released, the damper means performs free running and releases damping of a biasing force of the biasing means when the lid is positioned within a predetermined opening angle range. The damper means is also arranged to perform damping of a biasing force of the biasing means when the lid is positioned outside the predetermined opening angle range.

When the lock means is released, the lid is biased in an opening direction by the biasing means, and the rotating speed of the lid is slower in the start stage of the opening operation than in the end stage of the opening operation. Accordingly, by releasing damping of the biasing force during a state from a point that the lid starts to be opened to a point that the lid is opened through a predetermined angle, the lid can be opened speedily due to the biasing force of the biasing means during such a state.

Further, by damping the biasing force during a state from a point that the lid is opened through a predetermined angle from the opening start point to a point that the opening ends, the rotating speed of the lid is prevented from being increased, due to the damping force of the damper means; thus, the lid can be opened slowly.

Further, the biasing means and the damper means may be comprised of mutually independent components. Thus, it is possible to mount the biasing means and the damper means in different positions, whereby the freedom of design is increased.

Furthermore, the damper means may comprise: an engaging portion that is rotated in response to swinging of the lid; and a resistor member arranged to release engagement with the engaging portion and release damping of the biasing force when the lid is positioned within a predetermined opening angle range, the resistor member being also arranged to be disposed in engagement with the engaging portion and perform damping of the biasing force when the lid is positioned outside the predetermined opening angle range.

In the above-described structure, there is provided a resistor member arranged to release engagement with the engaging portion and release damping of the biasing force when the lid is positioned within a predetermined opening angle range, and damping of the biasing force is performed by means of the resistor member.

Further, in the above-mentioned aspect, the predetermined opening angle range of the lid is generally set to be from an angle that the lid is fully closed to 90°. Since the rotating speed of the lid is slow in the start stage of the opening operation, damping of the biasing force of the biasing means which causes the lid to be opened is released during a state from a point that the lid is fully closed to a point that the lid is opened through 90°, so that until a predetermined angle is reached, the lid can be opened speedily due to the biasing force of the biasing means.

Still further, in the above-mentioned aspect, it may be arranged such that: the biasing means is accommodated in a substantially cylindrical housing; the resistor member produces a damping force by virtue of a viscous material filled in a substantially cylindrical case. On the outer circumferences of said housing and said case is provided rotation preventing means for the shaft portion, serving as a rotation center about which the lid is swung, thereby preventing the housing and the case from being rotated with respect to the shaft portion.

### BRIEF DESCRIPTION OF THE DRAWINGS

FIG. 1 is a perspective view showing a cellular phone according to an embodiment of the present invention with a monitor portion opened.

FIG. 2 is an exploded perspective view of a hinge unit provided in the cellular phone according to the embodiment of the present invention.

FIG. 3A is a side view of the cellular phone according to the embodiment of the present invention, and

FIG. 3B is a sectional view of the hinge unit corresponding to FIG. 3A.

FIG. 4A is a side view of the cellular phone according to the embodiment of the present invention, and

FIG. 4B is a sectional view of the hinge unit corresponding to FIG. 4A.

FIG. 5A is a side view of the cellular phone according to the embodiment of the present invention, and

FIG. 5B is a sectional view of the hinge unit corresponding to FIG. 5A.

FIG. 6A is a side view of the cellular phone according to the embodiment of the present invention, and

FIG. 6B is a sectional view of the hinge unit corresponding to FIG. 6A.

FIG. 7A is a side view of the cellular phone according to the embodiment of the present invention, and

FIG. 7B is a sectional view of the hinge unit corresponding to FIG. 7A.

FIG. 8A is an explanatory diagram of the relationship between a cam surface and a cam groove of a cam body of an actuator constituting the hinge unit provided in the cellular phone according to the embodiment of the present invention.

FIGS. 9A and 9B are side views showing the relationship between a cam surface and a cam groove of a cam body of an actuator constituting the hinge unit provided in the cellular phone according to the embodiment of the present invention, FIG. 9A illustrating a state prior to sliding movement of the actuator, FIG. 9B illustrating a state immediately after sliding movement of the actuator.

FIGS. 10A and 10B are unrolled views showing manners of engagement between a cam surface of a sub cam and a projection of a stopper which constitute the hinge unit provided in the cellular phone according to the embodiment of the present invention,

FIG. 10A illustrating a manner of full engagement, FIG. 10B illustrating a manner of partial engagement.

FIG. 11 is an exploded perspective view of a damper unit provided in the cellular phone according to the embodiment of the present invention.

FIG. 12A is a side view of the cellular phone according to the embodiment of the present invention, and

FIG. 12B is a sectional view of the damper unit corresponding to FIG. 12A.

FIG. 13A is a side view of the cellular phone according to the embodiment of the present invention, and

FIG. 13B is a sectional view of the damper unit corresponding to FIG. 13A.

FIG. 14A is a side view of the cellular phone according to the embodiment of the present invention, and

FIG. 14B is a sectional view of the damper unit corresponding to FIG. 14A.

FIG. 15A is a side view of the cellular phone according to the embodiment of the present invention, and

FIG. 15B is a sectional view of the damper unit corresponding to FIG. 15A.

FIG. 16 is a perspective view showing a conventional hinge unit.

FIG. 17 is an exploded perspective view showing the conventional hinge unit.

### BEST MODE FOR CARRYING OUT THE INVENTION

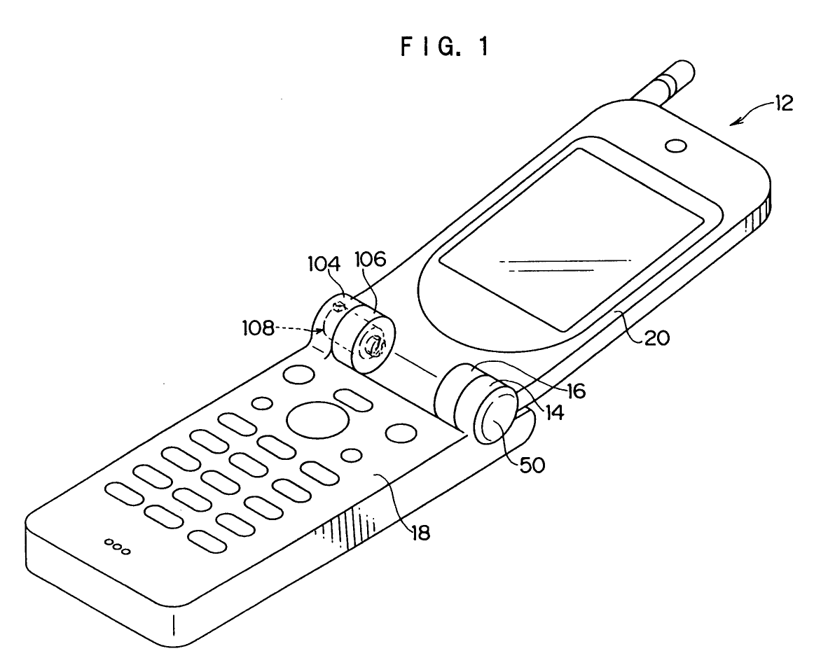

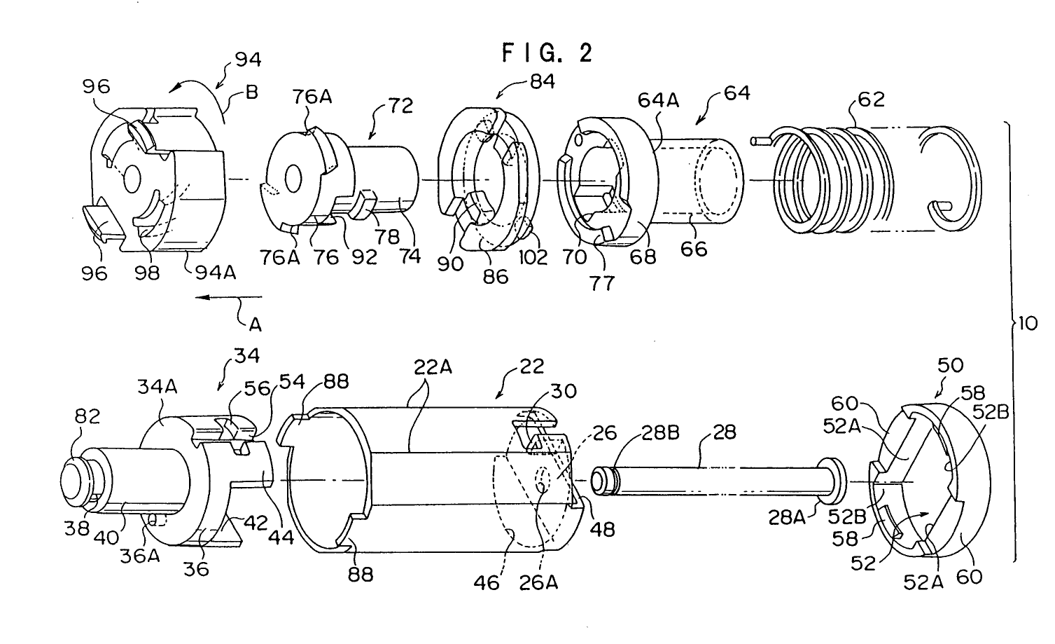

FIG. 1 shows a cellular phone 12 to which the folding electronic device application to the embodiment of the present invention is applied. The cellular phone 12 is provided with a pair of shaft portions 14, 16 and 104, 106. A hinge unit 10 (refer to FIG. 2) is provided in the shaft portions 14, 16, and a damper unit 108 is provided in the shaft portion 104, 106.

Here, the hinge unit 10 will first be explained.

The shaft portion 14, 16 is substantially cylindrical. The shaft portion 14 is provided on a transmitter portion (hereinafter, referred to as “base portion 18”), and the shaft portion 16 is provided on a receiver portion (hereinafter, referred to as “monitor portion 20”).

In the shaft portion 14, 16 is mounted the hinge unit 10 shown in FIG. 2 which includes a cylindrical case 22 having a plurality of angular portions 22A formed on the circumferential surface thereof and extending along an axial direction of the case 22.

On the other hand, the shaft portion 14 is concavely provided with a mounting portion (not shown) with which the outer circumferential surface of the case 22 is disposed in surface contact, whereby the case 22 can be fixed against rotation relative to the shaft 14 in a rotation preventing state.

A seating 26 is provided spanning the center portion of one end of the case 22 an aperture 26A is formed in the center of the seating 26. A shaft 28 is inserted through the aperture 26A, and located in position due to a flange portion 28A formed at one end of the shaft 28 being disposed in contact with the seating 26. Further, at the one end of the case 22, a notch is formed in a manner that it extends from the edge portion of the end in the axial direction of the case, and a bent piece 30 is provided which is bent inwardly of the case.

Further, a joint portion 34 can be accommodated in the case 22. At one end of the joint portion 34, there is provided a large-diameter portion 36, and at the other end thereof, there is provided a small-diameter portion 38. The large-diameter portion 36 and small-diameter portion 38 are interconnected by a medium-diameter portion 40.

A pair of mounting pieces 42, 44 extend from the outer circumference of one end of the large-diameter portion 36 along the axial direction of the joint portion 34. The mounting pieces 42, 44 can be inserted through arcuate openings 46, 48 provided at one end of the case 22, with the seating 26 interposed therebetween.

A substantially cylindrical button portion 50 can be mounted to the fore ends of the mounting pieces 42, 44 inserted through the arcuate openings 46, 48. At the mounting side, there is provided a substantially oblong recess 52 which is defined by flat surface portions 52A and curved surface portions 52B contiguous therewith.

The width of the recess 52 is substantially equal to that of the mounting pieces 42, 44, and thus the fore end surfaces of the mounting pieces can be brought into contact with the bottom surface of the recess 52 by causing the mounting pieces 42, 44 to be passed through the arcuate openings 46, 48.

The axial center portion of the joint portion 34 is hollow, and a shaft 28 is inserted therethrough so that the joint portion 34 is slidable along the axial direction of the shaft 28.

On the outer surface of the mounting piece 440there is provided an elongate groove 54 in which the bent piece 30 can be engaged. Thus, by accommodating the joint portion 34 in the case 22, the bent piece 30 is engaged in the elongate groove 54 so that the joint portion 34 is prevented from rotating relative to the case 22.

Further, in the outer surface of the mounting piece 44, there is an engaged groove 56 extending perpendicularly to the elongate groove 54, and also in the outer surface of the mounting piece 42, there is likewise provided an engaged groove 56. On the other hand, a pair of claws 58 are protruded from the rim areas of the curved surface portions 52B. In a state in which the mounting pieces 42, 44 are disposed in contact with the bottom surface of the recess 52, the claws 58 are engaged with the engaged grooves 56, and thus the joint portion 34 and the button portion 50 are permitted to slide together in the axial direction of the case 22.

Here, the width of the mounting pieces 42, 44 is substantially equal to the width of the recess 52 so that the mounting pieces 42, 44 can be inserted in the recess 52. Thus, in the state in which the fore end surfaces of the mounting pieces 42, 44 are disposed in contact with the bottom surface of the recess 52, the joint portion 34 and the button portion 50 are prevented from relative rotation.

Further, a pair of cradles 60 are concavely provided on arcuate end surfaces perpendicular to the flat surface portions 52A of the button portion 50, respectively. The cradles 60 have a width that is substantially equal to that of the seating 26 provided on the case 22, and thus they are engageable with the seating 26. In a state in which the cradles 60 are engaged with the seating 26, the button portion 50 is restrained from movement, and the joint portion 34 is also restrained from movement via the button portion 50.

In the other end of the large-diameter portion 36 is provided a mounting aperture 36A to which one end of a coil spring 62 is attached. The other end of the coil spring 62 is attached to a substantially cylindrical sub-cam 64, thereby biasing the joint portion 34 and sub-cam 64 in directions that they are spaced apart from each other. Further, the coil spring 62 is loosely wound so that a torsion force and compression force can be accumulated therein.

The sub-cam 64 is comprised of a cylindrical portion 66 and a cam portion 68 and accommodated in the case 22. Here, the cylindrical portion 66 is inserted through the medium-diameter portion 40 of the joint portion 34 so as to be slidable in a axial direction of the medium-diameter portion 40 and rotatable relative to the joint portion 34.

Further, a pair of engaging grooves 70 are formed in the inner circumference of the cylindrical portion 66 of the sub-cam 64 in such a manner as to extend along the axial direction of the cylindrical portion 66. Here, a substantially cylindrical actuator 72 can be inserted in the sub-cam 64. The actuator 72 is comprised of a cylindrical portion 74 and a cam portion 76. The cylindrical portion 74 has an engaging protrusion 78 provided on the outer circumference thereof, the engaging projection 78 being engageable with the engaging groove 70.

Thus, it is arranged such that the actuator 72 is rotatable together with the sub-cam 64, with the actuator 72 inserted in the sub-cam 64 and with the engaging projection 78 engaged in the engaging groove 70.

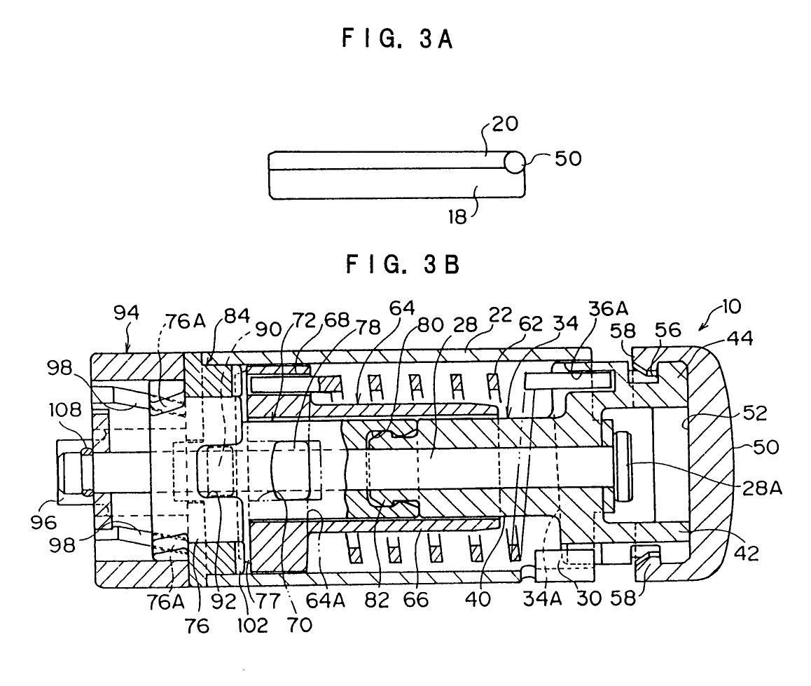

Further, the cylindrical portion 74 has an annular engaged portion 80 (refer to FIG. 3B) formed in the end portion of the inner circumference thereof which has a larger inner diameter than the remaining portion of the cylindrical portion 74. On the other hand, the small-diameter portion 38 of the joint portion 34 has an annular engaging portion 82 provided thereon which is engageable with the engaged portion 80.

Here, the inner diameter size of the engaged portion 80 is slightly larger than the outer diameter size of the engaging portion 82; thus, when the engaging portion 82 is engaged with the engaged portion 80, the joint portion 34 and the actuator 72 are slidable in unison in the axial direction of the shaft 28, and the actuator 72 is rotatable relative to the joint portion 32.

Meanwhile, an annular stopper 84 is disposed between the actuator 72 and the sub-cam 64. The outer diameter size of the stopper 84 is substantially equal to the inner diameter size of the case 22, and thus the stopper 84 is insertable in the case 22.

Further, the stopper 84 has a pair of flange portions 86 bulged from one end surface thereof, and is inserted in the case 22 with the flange portions 86 disposed in contact with the end surface of the case 22.

Between the flange portions 86 are provided spacings in which a pair of protrusion pieces 88 can be fitted which are protruded from the other end of the case 22. After having been fitted in the spacings, the protrusion pieces 88 are bent so as to be positioned between the flange portions 86. In this manner, the stopper 84 is fixed to the case 22.

Then, the other end surface of the stopper 84 is in contact with the sub-cam 64 (as described later), and thus, the sub-cam 64 is restrained from movement by the stopper 84. Here, the axial-direction length of the engaging groove 70 of the sub-cam 64 is made to be longer than the length of the engaging protrusion 78, and thus a difference in movement amount between the actuator 72 and the sub-cam 64 can be absorbed.

Meanwhile, on the outer peripheries of the flange portions 86, as on the outer circumference of the case, there are formed a plurality of angular portions 22A; thus, the stopper 84 can be fixed while being prevented from rotating relative to the shaft portion 14.

Here, on the inner circumference of the stopper 84, there are provided a pair of engaging protrusions 90. Meanwhile, engaging recesses 92 are formed by notching on the outer circumference of the cam portion 76 of the actuator 72, the engaging recesses 92 being engageable with the engaging protrusions 90. Thus, in a state in which the engaging recesses 92 are engaged with the engaging protrusions 90, the sub-cam 64 engaged with the actuator 72, and the actuator 72 is restrained from rotation.

Meanwhile, in a state in which the engaging recesses 92 are engaged with the engaging protrusions 90, the coil spring 62 is in a compressible state in which a torsion force can be accumulated therein. Thus, pressing the button portion 50 in a direction against a biasing force of the coil spring 62 causes the actuator 72 to be slid along with the joint portion 34 so that the engaging recesses 92 of the actuator 72 are released from the engagement with the engaging protrusions 90. In this manner, the actuator 72 is made to be rotatable, and is rotated via the sub-cam 64 due to a torsion force of the coil spring 62.

Meanwhile, a substantially cylindrical cam body 94 is mountable to the shaft portion 16 (refer to FIG. 1). On the outer circumference of the cam body 94, as on the outer circumference of the case 22, there is provided angular portions 94A extending in the axial direction of the cam body 94.

Further, on the shaft portion 16 is concavely provided a mounting portion (not shown) which is surface-contacted with the outer circumference of the cam body 94, thereby ensuring rotation preventing capability so as to prevent the cam body 94 from rotating relative to the shaft portion 16.

A pair of claw portions 96, which are protruded from the outer circumference of the cam body 94, are enagageable with engaged portions (not shown) formed on the mounting portion. Further, a pair of cam grooves 98, which are formed on the inner circumference of the cam body 94, are engageable with cam surfaces 76A of the cam portion 76 formed on the actuator 72.

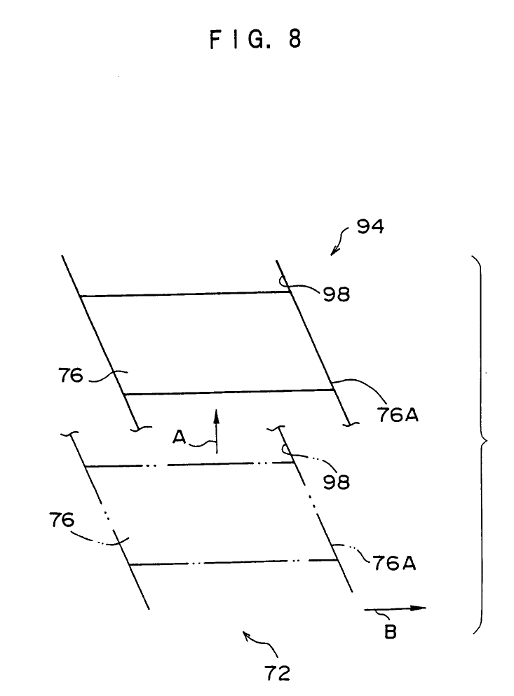

As shown in FIG. 2, the cam grooves 98 have a spiral form, and as shown in FIG. 8, sliding movement (in the direction indicated by arrow A) of the actuator 72 is converted to a torque to cause the cam body 94 to be rotated (in the direction indicated by arrow B (in the opening direction of the monitor portion 20)) via the cam grooves 98 which are engaged with the cam surfaces 76A.

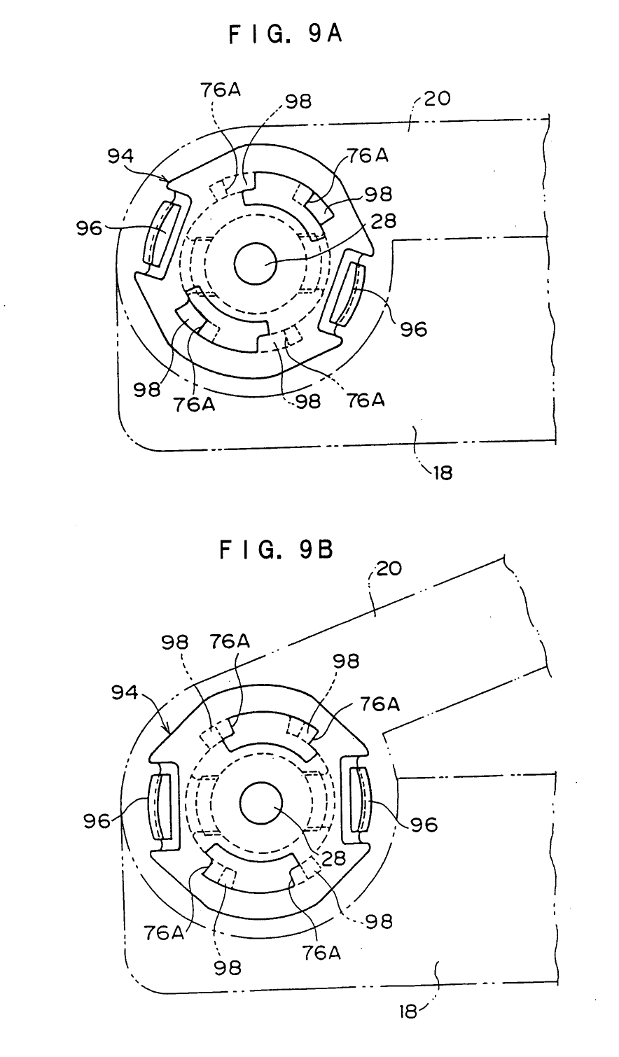

Further, FIGS. 9A and 9B illustrate a state in which the actuator 72 is moved in a direction perpendicular to the drawing plane, wherein although the moving state of the actuator 72 cannot be observed from the outward view, it can be seen that the cam surfaces 76A are engaged with those portions of the cam grooves 98 which are behind the drawing plane in FIG. 9A, and with those portions of the cam grooves 98 which are near to the drawing plane in FIG. 9B, and thus that the cam body 94 is rotated via the cam grooves 98.

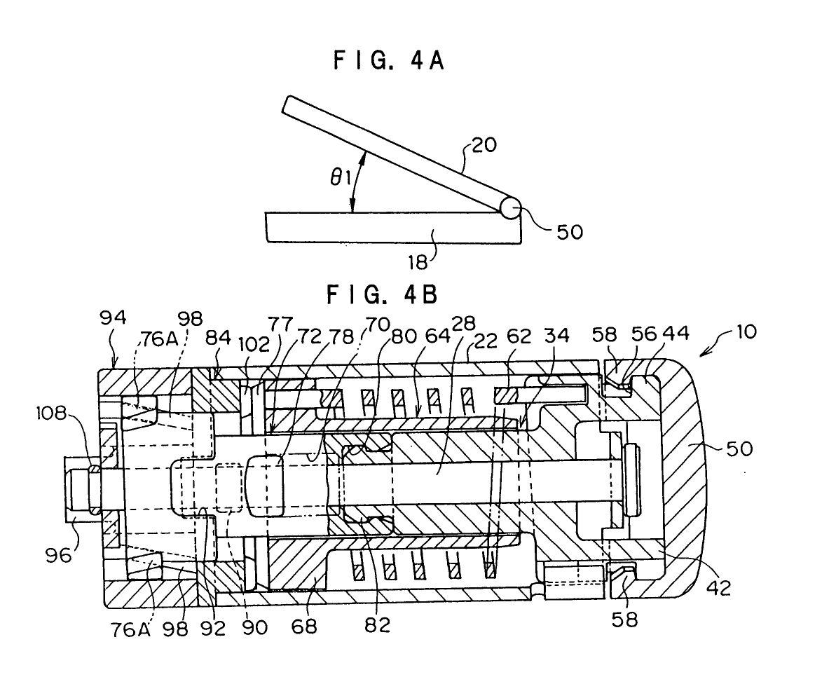

Here, as shown in FIGS. 4A and 4B, the actuator 72 is prevented from rotating from a point that the button portion 50 is depressed to a point that the engaging recesses 92 of the actuator 72 are released from engagement with the engaging protrusions 90, but the cam body 94 is permitted to rotate through a predetermined angle due to sliding movement of the actuator 72 which is caused by the depression of the button portion 50.

When the engagement of the actuator 72 and the stopper 84 is released, a torsion force is imparted to the actuator 72 by the coil spring 62 accommodated in the case 22, and thus the cam body 94 is rotated together with the actuator 72 so that the monitor portion 20 is opened.

With the base portion 18 and monitor portion which can be rotated relative to each other using the above-described hinge unit 10, it is possible to cause the monitor portion 20 to be opened conveniently through depression of the button portion 50, simply by mounting the shaft portion 14 in the case 22 and mounting the cam body 94 in the shaft portion 16.

Here, since a torque applied to the shaft portion 16 (refer to FIG. 1) varies greatly during a period of time from a point that the monitor portion 20 (refer to FIG. 1) is closed, to a point that it is fully opened, the opening manner of the monitor portion 20 is differentiated between a range that the cam body 94 is rotated by converting sliding movement of the actuator 72 to rotation of the cam body 94 and a range that the cam body 94 is rotated due to a torsion force of the coil spring 62, and thus the torque variations can be absorbed.

By causing the cam body 94 to be rotated reversely, on the other hand, a rotating force is transmitted to the cam portion 76 of the actuator 72 via the cam grooves 98 of the cam body 94, and thus the sub-cam 64 engaged with the actuator 72 is rotated.

Meanwhile, by depressing the button portion 50 when opening the monitor portion, the spacing distance between the joint portion 34 and the sub-cam 64 is decreased so that the coil spring 62 is compressed and a compression force is accumulated therein. In contrast, by causing the cam body to be rotated reversely, the sub-cam 64 is rotated reversely via the actuator so that a torsion force is accumulated in the coil spring 62.

Upon arrival of the engaging recesses 92 of the actuator 72 at a position engageable with the engaging protrusions 90 of the stopper 84 as a result of the cam body 94 being rotated reversely, as shown in FIG. 3B, the joint portion 34 is pulled back in a direction away from the sub-cam due to a restoration force resulting from the compression of the coil spring 34, while at the same time the button portion 50 is pushed out to the original position.

At this time, the actuator 72 is pulled back via the joint portion 34, and the engaging recesses 92 are engaged with the engaging protrusions 90 so that the actuator 72 is prevented from rotating; thus the sub-cam 64 is restrained from rotation via the actuator 72. Then, the cam body 94 is rotated in the closing direction (the direction opposite to the arrow B shown in FIG. 2) due to sliding movement of the actuator 72 (the direction opposite to the arrow A direction shown in FIG. 2).

As described above, the use of the coil spring 62 which can accumulate a torsion force and a compression force makes it possible that the single coil spring 62 works such that when opening, the monitor portion 20 is rotated by virtue of the torsion force, while the coil spring 62 remains compressed. Whereas when closing the monitor portion 20, after it is reversely rotated through a predetermined angle via the cam body 94 (storing torsion in coil 62) the actuator 72 is pulled back to a position where it engages with the stopper 84, by virtue of a restoration force resulting from the compression of the coil spring 62.

As will be appreciated from the above, the single coil spring 62 provides plural different functions to the hinge unit 10; thus, the number of parts of the hinge unit 10 can be decreased, the assembly thereof can be facilitated, and the manufacturing cost thereof can be reduced.

Meanwhile, the coil spring 62 is subjected to a compression load, so that the sub-cam 64 is thereby biased toward the stopper 84 in a state in which the stopper 84 is inserted in the case 22 and the other end surface of the stopper 84 is disposed in contact with the sub-cam 64.

The sub-cam 64 and joint portion 34 are provided with oblique surfaces 64A and 34A, respectively, which are disposed to face each other and between which is mounted the coil spring 62. The oblique surfaces 64A and 34A are slightly sloped with reference to a plane perpendicular to the axial direction of the shaft 28 so that the opposite end portions of the annular portion of the coil spring 62 can be disposed in contact with the oblique surfaces 64A and 34A and thus the biasing force of the coil spring 62 is uniformly imparted to the sub-cam 64.

Meanwhile, cam surfaces 77 are provided on the cam portion 76 of the sub-cam 64. From the other end surface of the stopper 84 is protruded a pair of protrusions 102 which are adapted to contact the cam surfaces 77 of the sub-cam 64.

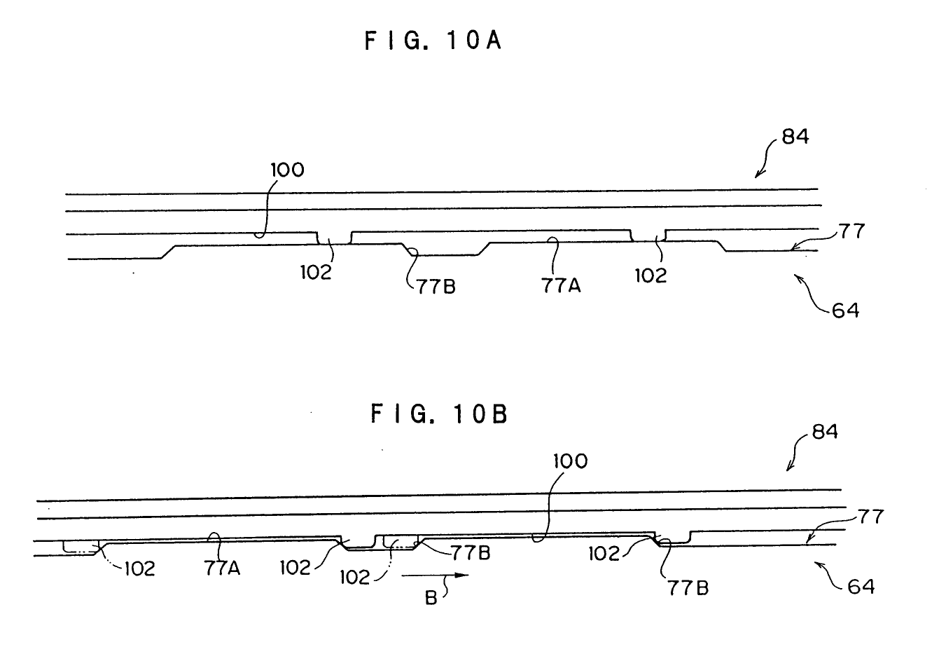

FIGS. 10A and 10B illustrate development views showing the manners of contact between the protrusions 102 and the cam surfaces 77. Rotation of the sub-cam changes the positions of the cam surfaces 77 where the protrusions 102 contact the cam surfaces 77, and thus the protrusions 102 and cam surfaces 77 have manners of contact varying from full surface contact to partial surface contact.

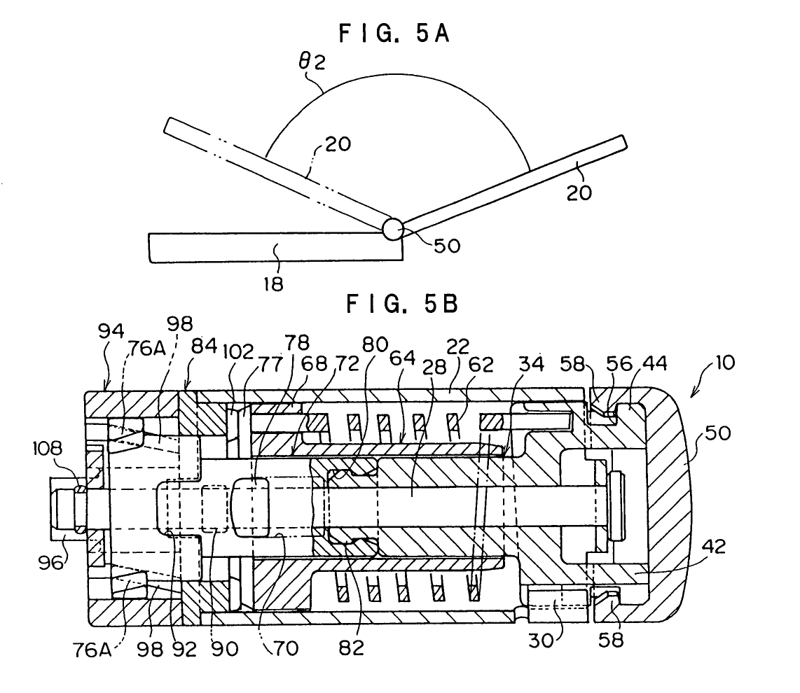

In a state in which the sub-cam 64 is being rotated, as shown in FIG. 5B and FIG. 10A, the protrusions 102 are disposed in full surface contact with the peak portions 77A. By virtue of the fact that the cam surfaces 77 are disposed in full surface contact with the protrusions 102, a constant friction force is produced within a predetermined angular range, and when the actuator 72 is released from engagement with the stopper 84 because of the button portion 50 being depressed, the monitor portion 20 is prevented from being fully opened rapidly.

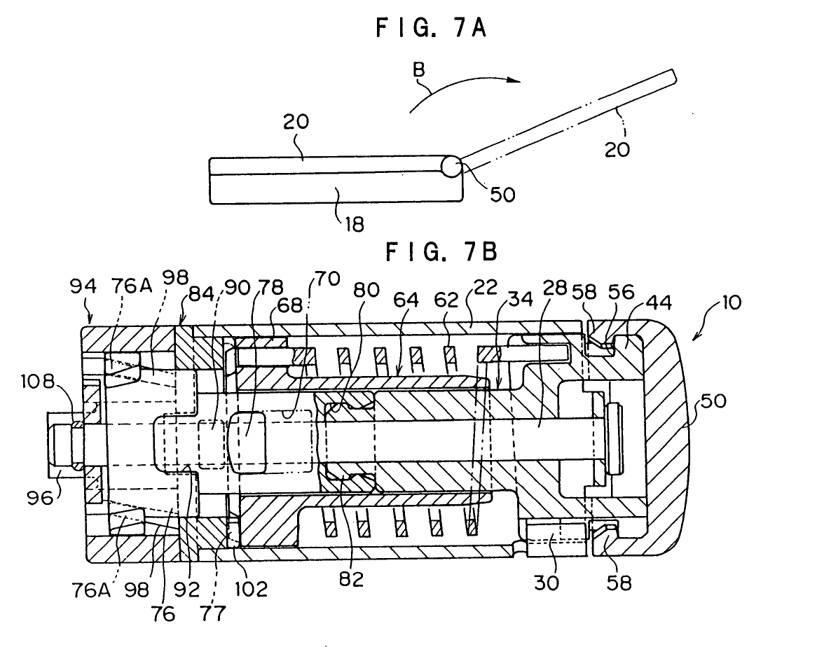

On the other hand, in a state in which the sub-cam 64 is stopped from rotation (in a fully opened state or in a fully closed state), as shown in FIGS. 7A and 7B and in FIG. 10B, the protrusions 102 are disposed in partial surface contact with inclined portions 77B of the cam surfaces 77.

In such a state, an axial thrust force received from the coil spring 62 due to a restoration force resulting from the compression of the coil spring 62 is converted to a rotating force by which the sub-cam 64 is rotated. Thus, at a fully opened position (dotted line) of the monitor portion 20, a rotating force in the arrow B direction is imparted to the sub-cam 64, and transmitted to the actuator 72 via the sub-cam 64 so that the fully opened state of the monitor portion 20 is maintained.

On the other hand, at a fully closed position (solid line) of the monitor portion 20, a rotating force in a direction opposite to the arrow B direction is imparted to the sub-cam 64, and transmitted to the actuator 72 via the sub-cam 64 so that the fully closed state of the monitor portion 20 is maintained.

As described above, in fully opened and closed states of the monitor portion 20, it is arranged such that by maintaining such states, the monitor portion 20 is prevented from rattling about in the fully opened and closed states.

Description will next be made of the damper unit 108.

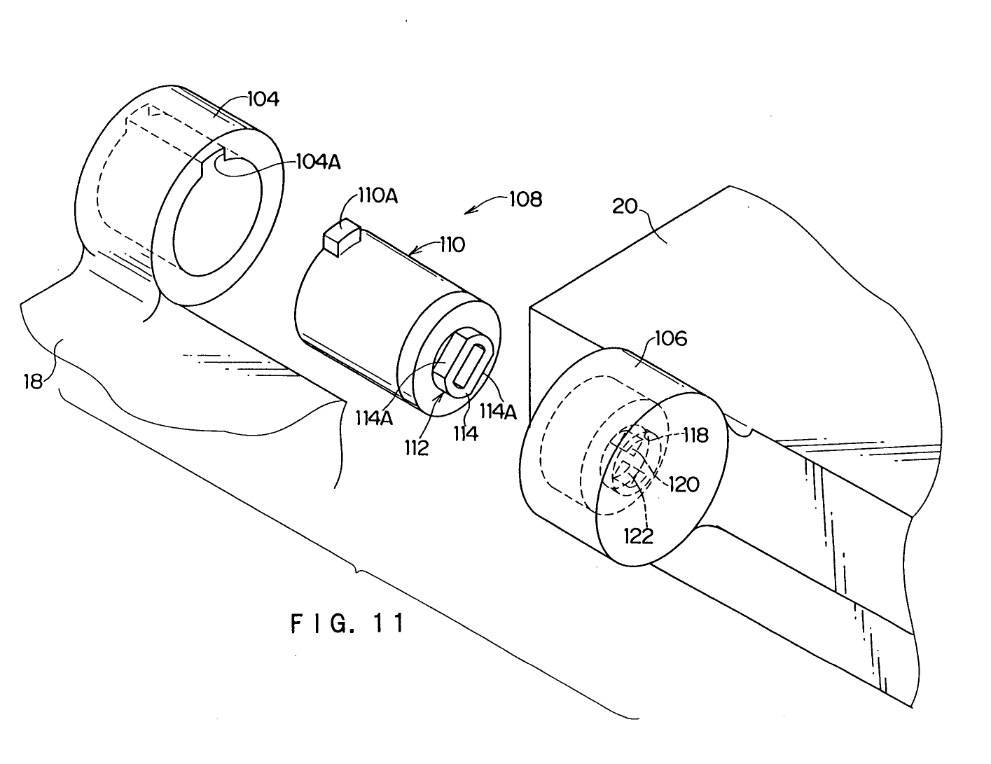

As shown in FIG. 11, the shaft portions 104, 106 are substantially cylindrical, the shaft portion 104 being provided on the base portion 18, the shaft portion 106 being provided on the monitor portion 20. A substantially cylindrical damper member 110 can be secured to the shaft portion 104.

A protrusion 110A is provided on the outer circumference of one end portion of the damper member 110. The protrusion 110A is engaged with a groove portion 104A formed on the inner circumference of the shaft portion 104 along the axial direction thereof, and is secured to the shaft portion 104 in such a manner that it is prevented from rotating relative to the shaft portion 104.

Further, one end portion of a shaft portion 112 is exposed from the center of the other end portion of the damper member 110, and a contacted portion 114 is provided on the exposed portion. The contacted portion 114 is substantially cylindrical and is formed with flat surface portions 114A in portions corresponding to the major axis arcs. Further, the shaft portion 112 is rotatably supported, and a blade body (not shown) extends from the outer circumference of the other end portion of the shaft portion 112.

Here, a fluid having a high viscosity coefficient such as silicone oil is filled in a body 116 of the damper member 110, and as the shaft portion 112 is rotated, the fluid is stirred by the blade body. In other words, viscosity resistance of the fluid is imparted to the shaft portion 112 via the blade body.

On the other hand, on the bottom surface of the shaft portion 106, there is provided a cylindrical recess 118 in which the contacted portion 114 can be inserted. A pair of contacting protrusions 120, 122 are protruded from the inner circumference of the cylindrical recess 118 toward the axial center thereof.

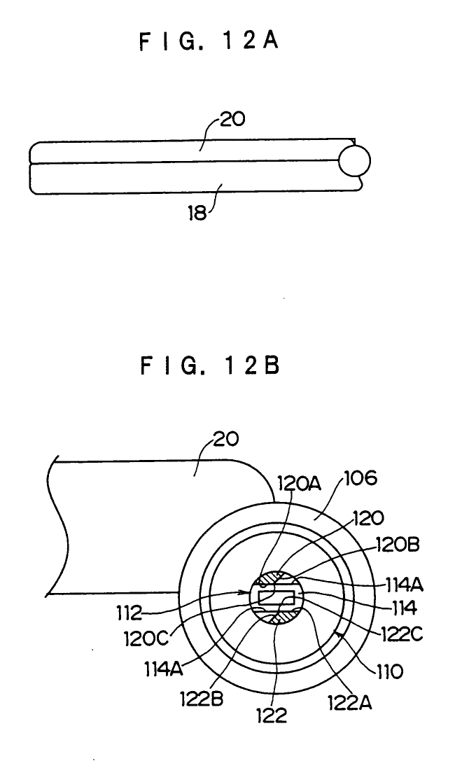

The contacting protrusions 120, 122 have a substantially triangular prism-like shape and are configured such that contacting surfaces 120A and 120B of the contacting protrusion 120 are parallel to contacting surfaces 122A and 122B of the contacting protrusion 122 respectively, as shown in FIG. 12B.

Here, the spacing distances between the contacting surface 120A and the contacting surface 122A and between the contacting surface 120B and the contacting surface 122B are substantially equal to the width size of the contacted portion 114 (the spacing distance between the flat surface portions 114A).

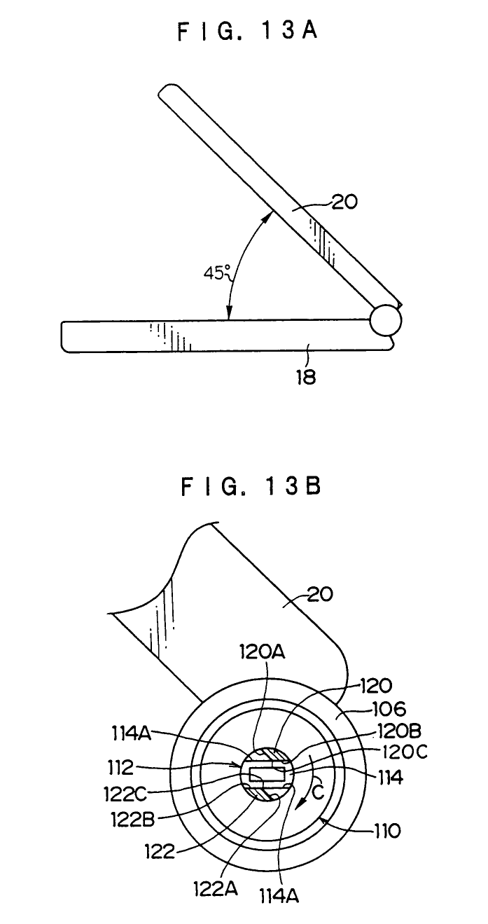

Further, the length (the amount jutting out from the inner circumference of the cylindrical recess 118) of the contacting surfaces 120A, 122A and 120B, 122B jutting out from the inner circumference of the cylindrical recess 118 is made to be approximately equal to ½ of the length of the flat surface portions 114A, and as shown in FIGS. 12B and 13B, the contacting surfaces 120A, 122A or the contacting surfaces 120B, 122B can be disposed in contact with the flat surface portions 114A.

The engagement relationship between the contacted portion 114 and the contacting protrusions 120, 122 will now be described.

In a state in which the monitor portion 20 is closed with respect to the base portion 18, as shown in FIGS. 12A and 12B, the contacting surfaces 120A and 122A are disposed in contact with the flat surface portions 1 14A of the contacted portion 114.

When the monitor portion 20 is opened through an angle of 450 with respect to the base portion 18, as shown in FIGS. 13A and 13B, the shaft portion 106 is rotated as the monitor portion 20 is rotated, and thus the positions of the contacting protrusions 120, 122 with respect to the contacted portion 114 are changed so that the contacting surfaces 120B and 122B are now disposed in contact with the flat surface portions 114A of the contacted portion 114.

That is, when the opening angle is in the range from 0° to 45°, only top portions 120C, 122C of the contacting protrusions 120, 122 are disposed in contact with the center portions of the flat surface portions 114A, and thus the shaft portion 112 is not rotated (so called idle running or lost motion).

On the other hand, when the monitor portion 20 is opened further than 450 with respect to the base portion 18, the falt surface portions 114A are pressed in the arrow C direction by the contacting protrusions 120, 122 while the contacting surfaces 120B, 122B remain disposed in contact with the flat surface portions 114A of the contacted portion 114. Thus, the shaft portion 112 is rotated via the flat surface portions 114a.

Consequently, the fluid in the body 116 of the damper member 110 is stirred by the blade body, and thus the shaft portion 112 receives viscosity resistance of the fluid via the blade body so that a damping force is exerted with respect to the monitor portion 20 via the shaft portion 106.

Description will next be made of the opening operation of a cellular phone according to this embodiment of the present invention.

First, with hinge unit 10, in a state in which the monitor portion 20 is closed with respect to the base portion 18, as shown in FIGS. 3A and 3B, a torsion force and a compression force are accumulated in the coil spring, and the engaging protrusions 90 of the stopper 84 are engaged with the engaging recesses 92 of the actuator 72 so that the actuator 72 is restrained from rotation.

At this time, as shown in FIG. 10B, a rotating force in a direction opposite to the arrow B direction is imparted to the sub-cam 64 due to a restoration force resulting from the compression received by the coil spring 62 (refer to FIG. 7A). Thus, the monitor portion 20 is prevented from rattling about when it is in a fully closed state.

Next, by depressing the button portion 50 extending from the right side surface of the monitor portion 20, as shown in FIGS. 4A and 4B, the joint portion 34 and actuator 72 are slid, through the action of the button portion 50, along the axial direction of the shaft 28.

At this time, due to the sliding movement of the actuator 72, the cam body 94 is rotated via the cam grooves 98 engaged with the cam portion 76; thus the monitor portion 20 to which the cam body 94 is secured is opened through θ1 θ1≦θ45°).

On the other hand, in the damper unit 108, as shown in FIGS. 12A, 12B and FIGS. 13A, 13B, the contacting protrusions 120, 122 provided on the shaft portion 106 are rotated as the monitor portion 20 is rotated, and the positions of the contacting protrusions 120, 122 are changed while the top portions 120C, 122C of the damper member 110 provided on the shaft portion 104 are disposed in contact with the center portions of the flat surface portions 11 4A. Thus, the shaft portion 112 remains in a stopped state, so that no damping force of the damper member 110 works on the monitor portion 20.

Next, on the hinge unit 10 side, when the engaging recesses 92 of the actuator 72 shown in FIGS. 3A and 3B are disengaged from the engaging protrusions 90 of the stopper 84, the engagement between the actuator 72 and the stopper 84 is released so that the actuator 72 becomes rotatable and is rotated relative to the case 22 via the sub-cam 64 due to a torsion force of the coil spring 62, as shown in FIGS. 5A and 5B. Consequently, the cam body 94 is rotated together with the actuator 72, and thus the monitor portion is further opened through θ2.

At this point, the cam surface 77 is disposed in surface contact with the protrusions 102 (refer to FIG. 10A), and a damping force for the monitor portion 20 is produced due to sliding resistance of the cam surfaces 77 and protrusions 102.

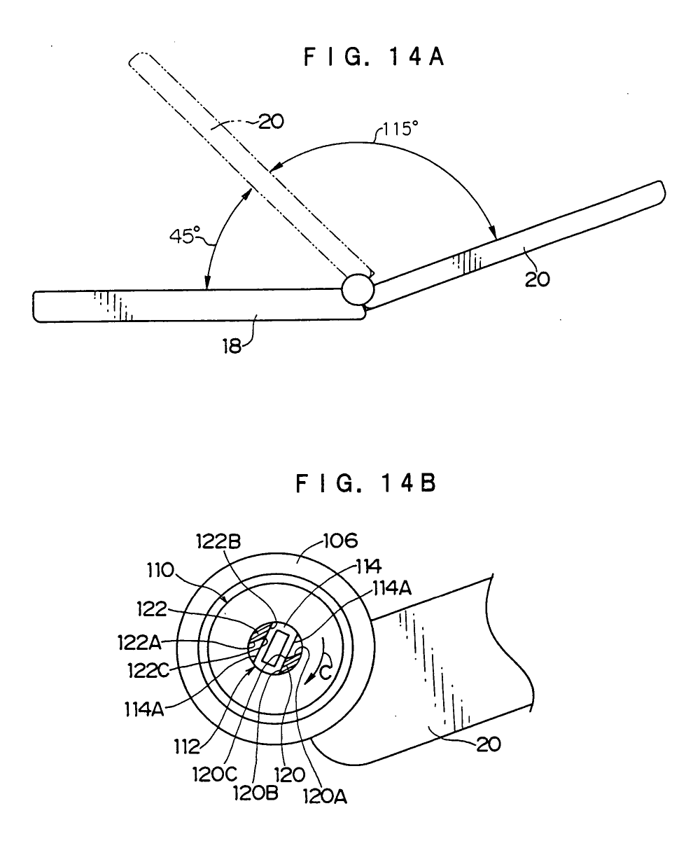

On the other hand, on the damper unit 10 side, when the opening angle of the monitor portion 20 becomes 45°, as shown in FIGS. 13A and 13B, the contacting surfaces 120B, 122B of the contacting protrusions 120, 122 are disposed in contact with the flat surfaces portions 114A of the contacted portion 114 of the damper member 110. With such a state maintained, the flat surface portions 11 4A are pushed in the direction of arrow C by the contacting protrusions 120, 122, and thus the shaft portion 112 is rotated via the flat surface portions 114A, as shown in FIGS. 14A and 14B.

As a result, the fluid in the body 116 of the damper member 110 is stirred by a non-illustrated blade body; thus the shaft portion 112 is subjected to viscosity resistance of the fluid via the blade body, and a damping force of the damper member 110 is obtained at the monitor portion 20 via the shaft portion 106.

Thus, while the opening angle of the monitor portion 20 ranges from 45° to 160°, it is possible to cause the monitor portion to be slowly opened due a damping force based on sliding resistance between the cam surfaces 77 and the protrusions 102 and due to a damping force based on viscosity resistance of the damper member 110 of the damper unit 108, thereby preventing the monitor portion 20 from receiving an impact when the opening of the monitor portion 20 is ceased. Here, when the monitor portion 20 is opened through an angle of θ1+θ2 (approximately 160° here), the monitor portion 20 is disposed in contact with the base portion 18 and stopped.

Further, in a state in which the monitor portion 20 is fully opened, as shown in FIG. 7A and FIG. 10B, a rotating force in the direction of arrow B is imparted to the sub-cam due to a restoration force resulting from compression of the coil spring 62, and thus the monitor portion 10 is prevented from rattling about when it is in a fully opened state.

Description will next be made of the closing operation of the cellular phone according to this embodiment of the present invention.

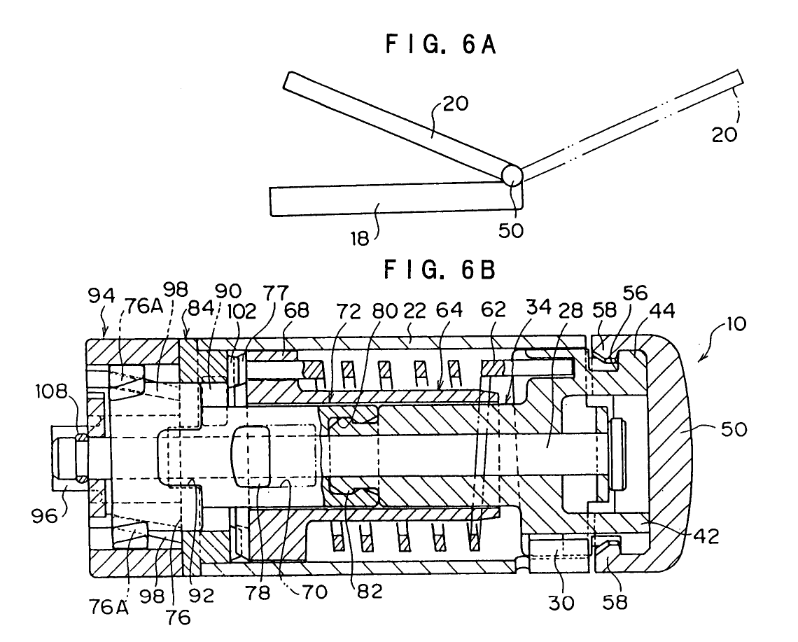

First, on the hinge unit 10 side, as shown in FIGS. 6A and 6B, the monitor portion 20, which is fully opened, is reversely rotated in the closing direction with respect to the base portion 18. At this point, the actuator 72 and sub-cam 64 are reversely rotated via the cam body 94, and thus a torsion force is accumulated in the coil spring 62.

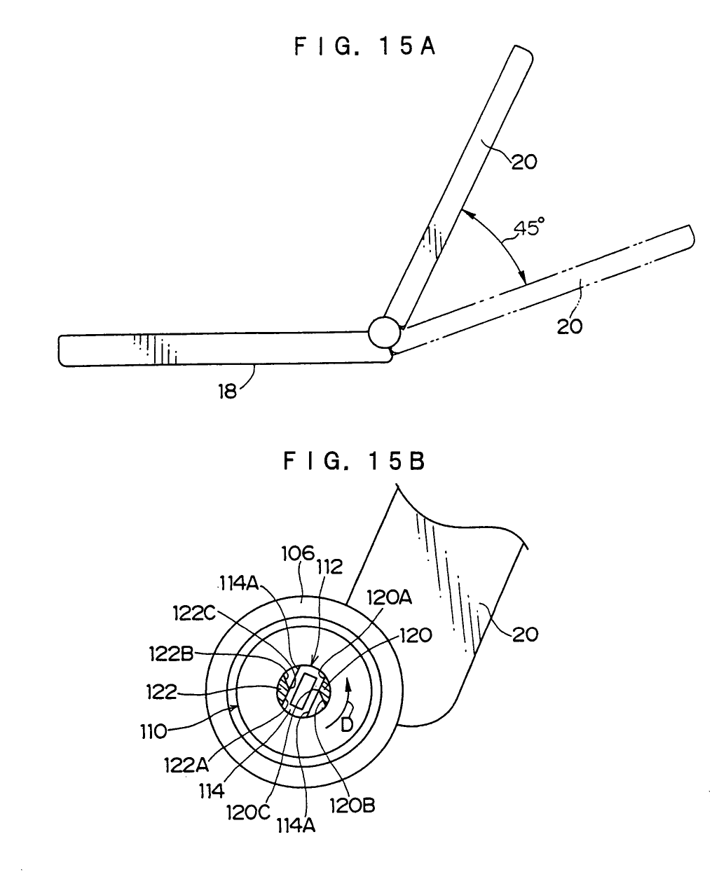

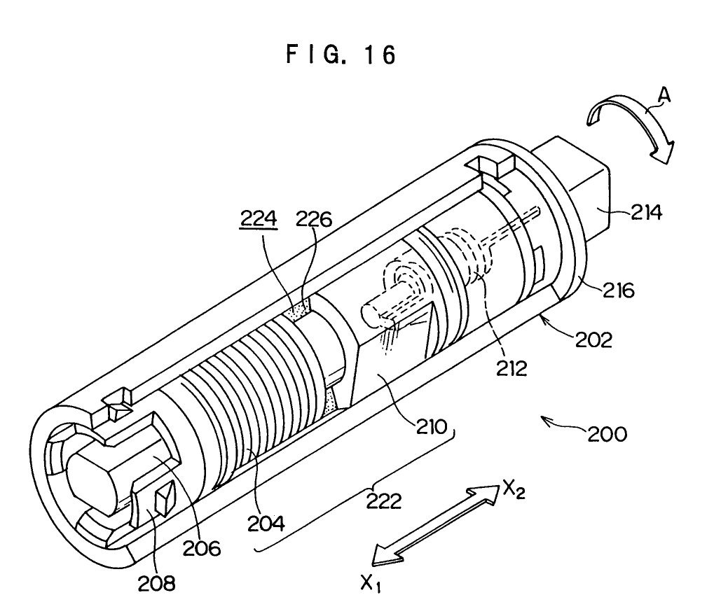

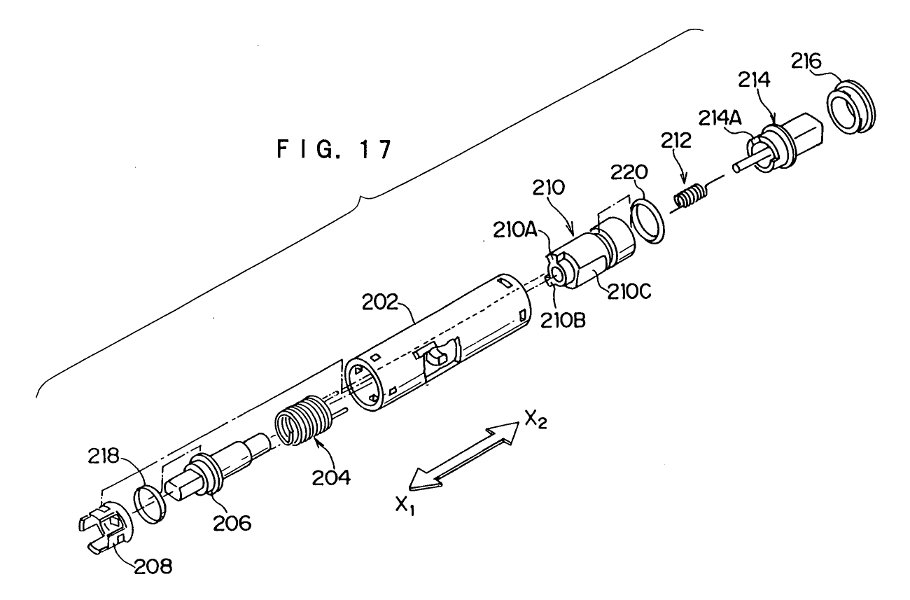

On the damper unit 108 side, as shown in FIGS. 14A and 14B, the contacting surfaces 120B, 122B of the contacting protrusions 120, 122 are disposed in contact with the flat surface portions 114A of the contacted portion 114 of the damper member 110. As shown in FIGS. 15A and 15B, during a period of time until the contacting surfaces 120A, 122A of the contacting protrusions 120, 122 are brought into contact with the flat surface portions 114A of the contacted portion 114 of the damper member 110 (in a state in which closing through an angle of 45° from the fully opened state is made), simply the positions of the contacting protrusions 120, 122 are changed, and the shaft portion 112 remains stopped, while the top portions 120C, 122C of the contacting protrusions 120, 122 are disposed in contact with the center portions of the flat surface portions 144A of the contacted portion 114 of the damper member 110. Hence, no damping force of the damper member 110 works on the monitor portion 20.

Then, during a period of time until the monitor portion 20 is closed, as shown in FIGS. 12A and 12B, from the state of FIGS. 15A and 15B, with the contacting surfaces 120A, 122A of the contacting protrusions 120, 122 disposed in contact with the flat surface portions 114A of the contacted portion 114 of the damper member 110, the contacting protrusions 120, 122 press the flat surface portions 114A in the direction of arrow D and cause the shaft portion 112 to be rotated. Thus, a damping force is exerted on the monitor portion 20 due to viscosity resistance of the damper member 110.

Next, as shown in FIGS. 4A and 4B when the engaging recesses 92 of the actuator 72 arrive at positions engageable with the engaging protrusions 90 of the stopper 84, the joint portion 34 is pulled back in the direction away from the sub-cam 64 due to a restoration force resulting from the compression of the coil spring 62, while at the same time the button portion 50 is pushed out to the original position, as shown in FIGS. 3A and 3B.

Then, the actuator 72 is pulled back via the joint portion 34 and stopped from rotating, and the sub-cam 64 is restrained from rotation. At this point, the cam body 94 is rotated in the closing direction due to sliding movement of the actuator 72.

As shown in FIGS. 7A and 10B, an axial thrust force received from the coil spring 62 is converted to a rotating force due to a restoration force resulting from the compression of the coil spring 62, and the rotating force in the direction opposite to the arrow B direction is imparted to the sub-cam 64, thereby preventing the monitor portion from rattling about in a state in which it is fully opened.

The operation of the cellular phone according to this embodiment of the present invention will next be described.

As shown in FIGS. 12A and 12B and FIGS. 13A and 13B, during transition from a state in which the monitor portion 20 is fully closed to a state in which the opening angle of the monitor portion 20 is 45°, the contacting protrusions 120, 122 provided in the shaft portion 106 are rotated as the monitor portion 20 is rotated, and the positions of the contacting protrusions 120, 122 are only changed while the top portions 120C, 122C of the contacting protrusions 120, 122 are disposed in contact with the center portions of the flat surface portions 114A of the contacted portion 114 of the damper member 110. Thus, the shaft portion 112 remains in a stopped state, and no damping force works on the monitor portion 20.

By depressing the button portion 50 projected from the right side surface of the monitor portion 20 in a state in which the monitor portion 20 is fully closed, as shown in FIGS. 4A and 4B, the joint portion 34 and the actuator 72 are slid along the axial direction of the shaft 28 via the button portion 50, and thus the cam body 94 is rotated via the cam grooves 98 engaged with the cam portion 76, so that the monitor portion 20 to which the cam body is secured is opened. In this case, the opening of the monitor portion 20 can be performed speedily by releasing the damping force by the damper member 110.

When the opening angle of the monitor portion 20 becomes 45°, the contacting surfaces 120A, 120B of the contacting protrusions 120, 122 are disposed in contact with the flat surface portions 114A of the contacted portion 114 of the damper member 110, as shown in FIGS. 13A and 13B, and during this state, the contacting protrusions 120, 122 press the flat surface portions 114A in the direction of arrow C, and cause the shaft portion 112 to be rotated via the flat surface portions 114A, thereby exerting a damping force of the damper member 110 on the monitor portion 20.

Thus, during transition from the state in which the opening angle of the monitor portion 20 is 45° to the state in which the opening of the monitor portion 20 is finished, the rotation speed of the monitor portion 20 is kept from increasing due to a torsion force of the coil spring 62 (refer to FIG. 2), and thus the monitor portion 20 can be slowly opened.

Since the hinge unit 10 and the damper member 110 are each comprised of separate and different components, the hinge unit 10 and the damper member 110 can be mounted at different positions, and thus the freedom of design is increased.

Although in this embodiment, it is arranged such that during transition from a state in which the monitor portion 20 is opened through 45° to a state in which the monitor portion 20 is fully opened (160°), a damping force by the damper member 110 can be obtained on the monitor portion 20, it is only required that an appropriate angle be set depending on a torque variation, and therefore the angle is by no means limited to 45° or 160°.

Further, although here, it is arranged such that a damper effect can be obtained by the hinge unit 10 as well, it is not always to necessary to add a damper effect to the hinge unit 10, and it can also be arranged such that a damping force is obtained on the monitor portion 20 due to the damper effect of the damper unit 108 alone.

Still further, although the damper member 110 is arranged such that a damper effect is obtained irrespective of the direction of rotation of the shaft 112, it is also possible that the damper member 110 is formed as a one-way damper which is adapted to produce damping only in the case of rotation in one-direction. Hence, it can also be arranged such that a damper effect is obtained when the monitor portion 20 is opened while the damper effect is released when the monitor portion 20 is closed.

Furthermore, although the components of the hinge unit 10 were accommodated together in a case, it is also possible that the shaft of the housing may be used as a case and the components may be directly incorporated therein. However, in view of the effort required for such incorporation, it is preferable that the components be incorporated in the case 22 as in this embodiment of the present invention.

Moreover, although herein the monitor portion 20 is opened by depressing the button portion 50, it is needless to say possible to cause the monitor portion 20 to be opened without depressing the button portion 50. In such a case, by rotating the monitor portion 20 through θ1 (refer to FIGS. 4A and 4B), the actuator 72 is slid via the cam grooves 98 of the cam body 94 which is rotated in unison with the monitor portion 20.

The present invention is by no means limited to a cellular phone since it is applicable in any case where a pair of housings are relatively rotated. For instance, the present invention is also applicable in any case where the opening angle is predetermined like in the case of a lid for audio-video (AV) equipment.

In the above-described structure of the present invention, by releasing the damping of the biasing force during a state from a point that the lid starts to be opened to a point that the lid is opened through a predetermined angle, the lid can be speedily opened due to the biasing force of the biasing means during the above state. Further, by damping the biasing force during a state from a point that the lid is opened through a predetermined angle from the start of opening of the lid to a point that the opening of the lid is completed, the rotating speed of the lid is prevented from increasing, due to a damping force by the damper means, and thus the lid can be opened slowly.

Further, the freedom of design is increased by virtue of the fact that the biasing means and the damper means can be mounted at different positions. By setting a predetermined angle in a range from the fully closed angle of the lip to 90°, and by releasing, during this range, the damping of the biasing force of the biasing means which permits the lid to be opened, the lid can be opened speedily due to the biasing force of the biasing means. By mounting the housing and the damper member on respective cylindrical shaft portions, and by providing rotating preventing means, the housing and the damper member can be prevented from rotating with respect to the shaft portions.

### INDUSTRIAL APPLICABILITY

The present invention is applicable to an electronic device such as an electronic device having a lid like a cellular phone of the type that a receiver portion is mounted to be swingable with respect to a body, or a personal computer of the type that a display is provided in a lid, or to an opening/closing mechanism for such an electronic device.

What is claimed is:

1. An electronic device having a body and a lid comprising:
a spindle portion including a mechanism for supporting and permitting the lid to be swung in a direction that said lid is opened from a closed position where the lid is closed by folding with respect to the body;
a biasing mechanism provided on said spindle portion for biasing said lid in the direction that the lid is opened, thereby enabling the lid to perform an opening operation; and
a damper mechanism for damping the opening operation of said lid, the damper mechanism being arranged to perform no damping operation during a state in which said lid, when opened, is in a range from a fully closed position to an angle less than or equal to a predetermined angle, the damper mechanism being also arranged to operate damping of the opening operation of said lid during a state in which said lid is opened through an angle in excess of the predetermined angle.

2. The electronic device according to claim 1, wherein said spindle portion includes a lock mechanism for holding said lid at the closed position when the lid is located at the closed position, and a release mechanism for releasing the holding of the lid by the lock mechanism.

3. The electronic device according to claim 2, wherein said lock mechanism holds said lid at the closed position in a state in which a biasing force by the biasing mechanism is permitted to be accumulated.

4. The electronic device according to claim 2, wherein: said spindle portion includes a cam structure; said release mechanism includes a portion that is moved in response to a releasing manipulation, the release mechanism being connected to the cam structure via said portion; and the lid starts to be moved in an opening direction in response to the releasing manipulation.

5. An opening/closing mechanism for the electronic device according to claim 1, further comprising at least one additional spindle portion, wherein each of the biasing mechanism and the damper mechanism is provided on a different one of the spindle portions.

6. The electronic device according to claim 1, wherein: said damper mechanism includes an engaging mechanism; and the engaging mechanism includs a shaft that releases interlocking with said lid during a state in which the lid, when opened, is in a range from a fully closed position to an angle less than or equal to a predetermined angle and interlocks with said lid during a state in which the lid is opened through an angle in excess of the predetermined angle.

7. An opening/closing mechanism for the electronic device according to claim 6, wherein: the damper mechanism includes a substantially cylindrical container filled with a viscous medium; and said shaft has a blade body in the viscous medium and is rotatably supported.

8. An opening/closing mechanism for an electronic device including a body and a lid, comprising:
a spindle mechanism for supporting and permitting said lid to be swung in a direction that the lid is opened from a closed position that the lid is closed by folding with respect to the body;
a biasing mechanism for biasing said lid in the direction that the lid is opened, thereby enabling the lid to perform an opening operation; and
a damper mechanism for damping the opening operation of the lid, the damper mechanism being arranged to perform no damping operation during a state in which the lid, when opened, is in a range from a fully closed position to an angle less than or equal to a predetermined angle and to operate damping of the opening operation of the lid during a state in which the lid is opened through an angle in excess of the predetermined angle.

9. The opening/closing mechanism for an electronic device according to claim 8, further comprising: a lock mechanism for holding said lid at the closed position when the lid is located at the closed position; and a release mechanism for releasing the holding operation by the lock mechanism.

10. The opening/closing mechanism for an electronic device according to claim 9, wherein said lock mechanism holds said lid at the closed position in a state in which a biasing force by the biasing mechanism is caused to be accumulated.

11. The opening/closing mechanism for an electronic device according to claim 9, wherein said release mechanism includes a portion that is moved in response to a releasing manipulation when the releasing manipulation is performed, and said portion is connected to the lock mechanism to release the holding operation.

12. The opening/closing mechanism for an electronic device according to claim 11, further comprising a cam structure, said portion of the release mechanism being connected to the cam structure to permit the lid to start moving in an opening direction.

13. The opening/closing mechanism for an electronic device according to claim 8, wherein the biasing mechanism comprises an elastic member, and the lid is biased due to a restoration force of the elastic member.

14. The opening/closing mechanism for an electronic device according to claim 13, wherein said elastic member comprises a coil spring.

15. The opening/closing mechanism for an electronic device according to claim 8, wherein said biasing mechanism and said damper mechanism are disposed to be combined respectively with different portions of said spindle mechanism.

16. The opening/closing mechanism for an electronic device according to claim 8, further comprising at least one additional spindle mechanism, wherein each of the biasing mechanism and the damper mechanism is combined with a different one of the spindle mechanisms.

17. The opening/closing mechanism for an electronic device according to claim 8, wherein: said damper mechanism includes an engaging mechanism; and the engaging mechanism includes a shaft that releases interlocking with said lid during a state in which the lid, when opened, is in a range from a fully closed position to an angle less than or equal to a predetermined angle, and interlocks with said lid during a state in which the lid is opened through an angle in excess of the predetermined angle.

18. The opening/closing mechanism for an electronic device according to claim 8, wherein said damper mechanism has a structure that produces a damping force by using the viscosity of a viscous medium.

19. The opening/closing mechanism for an electronic device according to claim 17, wherein: the damper mechanism includes a cylindrical container filled with a viscous medium; and said shaft has a blade body in the viscous medium and is rotatably supported.

20. The opening/closing mechanism for an electronic device according to claim 8, wherein said predetermined angle is less than or equal to 90°.

21. The opening/closing mechanism for an electronic device according to claim 8, wherein said electronic device is a cellular phone device having a receiver portion provided in said lid.

22. A folding type electronic device wherein there is provided a lid that is swingable with respect to a body, the electronic device characterized by comprising:
a shaft portion about which the lid is swung;
biasing means provided in said shaft portion for biasing said lid in an opening direction, thereby causing the lid to be opened;
lock means for maintaining a closed position of said lid in a state in which an elastic force of said biasing means is accumulated; and
damper means provided in said shaft portion, said damper means being arranged, after said lock means is released, to perform free running and release damping of a biasing force of said biasing means when said lid is positioned within a predetermined opening angle range, said damper means being also arranged to perform damping of a biasing force of said biasing means when said lid is positioned outside the predetermined opening angle range.

23. The electronic device according to claim 22, characterized in that said biasing means and said damper means are comprised of mutually independent components.

24. The electronic device as described in claim 22, characterized in that said damper means comprises: an engaging portion that is rotated in response to swinging of said lid; and a resistor member arranged to release engagement with said engaging portion and release damping of the biasing force when the lid is positioned within a predetermined opening angle range, the resistor member being also arranged to be disposed in engagement with the engaging portion and perform damping of the biasing force when said lid is positioned outside the predetermined opening angle range.

25. The electronic device as described in claim 22, characterized in that the predetermined opening angle range of said lid is from a fully closed state of the lid to 90°.

26. The electronic device as described in claim 24, characterized in that: said biasing means is accommodated in a substantially cylindrical housing; said resistor member produces a damping force by virtue of a viscous material filled in a substantially cylindrical case; and rotation preventing means for said shaft portion is provided on outer circumferential surfaces of said housing and said case.
